(19) United States
(12) Patent Application Publication
(10) Pub. No.: US 2019/0341667 A1
(43) Pub. Date: Nov. 7, 2019

(54) IN LINE E-PROBE WAVEGUIDE TRANSITION

(71) Applicant: WHIRLPOOL CORPORATION, BENTON HARBOR, MI (US)

(72) Inventor: Francesco Giordano, Cremona (IT)

(73) Assignee: WHIRLPOOL CORPORATION, BENTON HARBOR, MI (US)

(21) Appl. No.: 15/970,925

(22) Filed: May 4, 2018

(51) Int. Cl. H01P 5/02; H01P 1/04; H01P 3/12; H05B 6/68; H05B 6/70; H05B 6/72

(52) U.S. Cl. CPC H01P 5/024; H01P 1/042; H01P 3/12; H05B 6/705; H05B 6/707; H05B 6/72; H05B 6/687

(57) ABSTRACT

A transition device for a hollow waveguide comprises a rectangular structure comprising an inlet wall and interior extending from the inlet wall along a longitudinal axis. The inlet wall is configured to receive a transmission line comprising an antenna. The antenna forms a proximal end proximate to the inlet wall and a distal end configured to extend into the rectangular structure of the hollow waveguide. A channel is formed in the rectangular structure. The channel comprises a base forming a tuning surface. The tuning surface is configured to extend along a length of the antenna in a spaced configuration parallel to the longitudinal axis.

### TECHNOLOGICAL FIELD

The present device generally relates to a waveguide for electromagnetic field propagation, and, more specifically, to a longitudinal transition for a waveguide.

### BACKGROUND

Microwave transmitters are commonly connected to cavities of microwave ovens via transmission lines. Such transmission lines may be coupled to cooking cavities of microwaves via waveguides. The disclosure provides for a novel transition for a longitudinal waveguide as described in the following detailed description.

### SUMMARY

In at least one aspect, a transition device for a hollow waveguide is disclosed. The device comprises a rectangular structure comprising an inlet wall and interior extending from the inlet wall along a longitudinal axis. The inlet wall is configured to receive a transmission line comprising an antenna. The antenna forms a proximal end proximate to the inlet wall and a distal end configured to extend into the rectangular structure of the hollow waveguide. A channel is formed in the rectangular structure. The channel comprises a base forming a tuning surface. The tuning surface is configured to extend along a length of the antenna in a spaced configuration parallel to the longitudinal axis.

In at least another aspect, a method for generating an electrical field in a hollow waveguide is disclosed. The method comprises transmitting electrical current at a frequency into an inlet wall of the hollow waveguide via a transmission line. The method further comprises emitting electromagnetic energy radially from an antenna at the frequency perpendicular to a longitudinal axis of the hollow waveguide. The method further comprises tuning the electromagnetic energy via an excitation surface of a channel that at least partially bisects the hollow waveguide. The method additionally comprises controlling the electromagnetic energy via the channel in a cavity extending between the inlet wall and the channel. The electromagnetic energy is controlled to propagate parallel to the longitudinal axis of the hollow waveguide. In at least another aspect, a transition device for a hollow waveguide is disclosed. The transition device comprises an elongated rectangular structure comprising an inlet wall and an interior volume extending from the inlet wall along a longitudinal axis. The inlet wall is configured to receive a transmission line comprising an antenna forming a proximal end proximate to the inlet wall and a distal end configured to extend into the rectangular structure. A capacitive channel is formed through a width of the rectangular structure substantially perpendicular to the longitudinal axis. The capacitive channel comprises a base portion forming a tuning surface. The tuning surface is configured to extend along a length of the antenna in a space configuration parallel to the longitudinal axis of the elongated rectangular structure.

These and other features, advantages, and objects of the present device will be further understood and appreciated by those skilled in the art upon studying the following specification, claims, and appended drawings.

### BRIEF DESCRIPTION OF THE DRAWINGS

In the drawings:

FIG. 1 is a projected schematic view of a longitudinal transition device for a hollow waveguide;

FIG. 2 is a detailed projected schematic view of the longitudinal transition device depicted in the FIG. 1;

FIG. 3 is a side schematic view of a transition portion of the hollow waveguide depicted in FIG. 1;

FIG. 4 is a projected view of a transition device for a hollow waveguide demonstrating the electromagnetic field lines simulated at a target input frequency; and

FIG. 5 is a plot of the simulated power reflected by the waveguide back to an inlet in accordance with the disclosure.

### DETAILED DESCRIPTION OF EMBODIMENTS

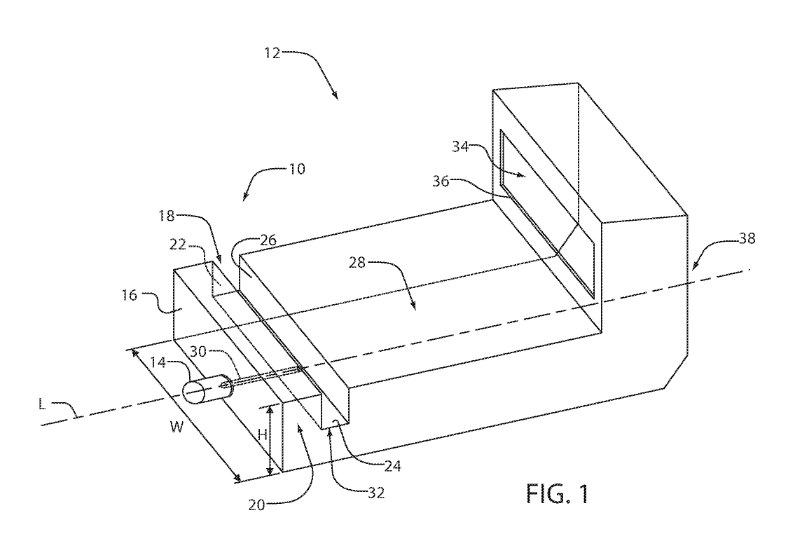

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to FIG. 1, a projected view of a longitudinal transition device 10 for a hollow waveguide 12 is shown. The transition device 10 may be configured to receive a transmission line 14 via an inlet wall 16. The waveguide 12 may generally form an elongated rectangular form having a Height and a Width extending along a longitudinal axis L. In this configuration, the longitudinal transition device 10 may provide for an inline transition for the transmission line 14 configured to generate transverse electric propagation of electromagnetic radiation transmitted through the waveguide 12 along the longitudinal axis L.

In an exemplary embodiment, a rectangular channel 18 may be formed through the width W of the hollow waveguide 12. In this configuration, the rectangular channel 18 may form a cavity 20 extending from the inlet wall 16 to a first wall 22 of the rectangular channel 18. A base portion 24 may extend from the first wall 22 of the rectangular channel 18 to a second wall 26 of the rectangular channel 18. In this configuration, the rectangular channel 18 may at least partially bisect an interior volume 28 of the hollow waveguide 12 providing for the cavity 20 to be formed proximate to the inlet wall 16. Accordingly, the first wall 22 and the opening formed by the channel 18 may define a length of the cavity 20.

The transition device 10 of the waveguide 12 may be configured to receive a probe 30 or antenna extending through the inlet wall 16 from the transmission line 14. The probe 30 may extend along the longitudinal axis L of the waveguide 12 from a proximal end portion 30a at the inlet wall 16 to a distal end portion 30b. The distal end portion 30b may terminate proximate to the second wall 26 of the rectangular channel 18. In this configuration, the probe 30 may extend parallel to a tuning surface 32 within the interior volume 28 formed by the base portion 24 of the rectangular channel 18. In this configuration, the rectangular channel 18 may form a cutout portion extending transverse to the longitudinal axis L of the waveguide 12 and provide a capacitive tuning channel (e.g. the rectangular channel 18) via the tuning surface 32.

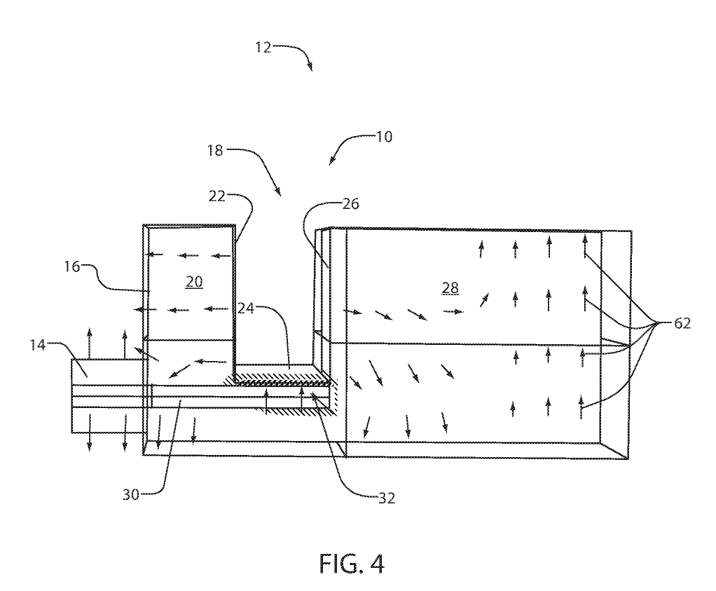

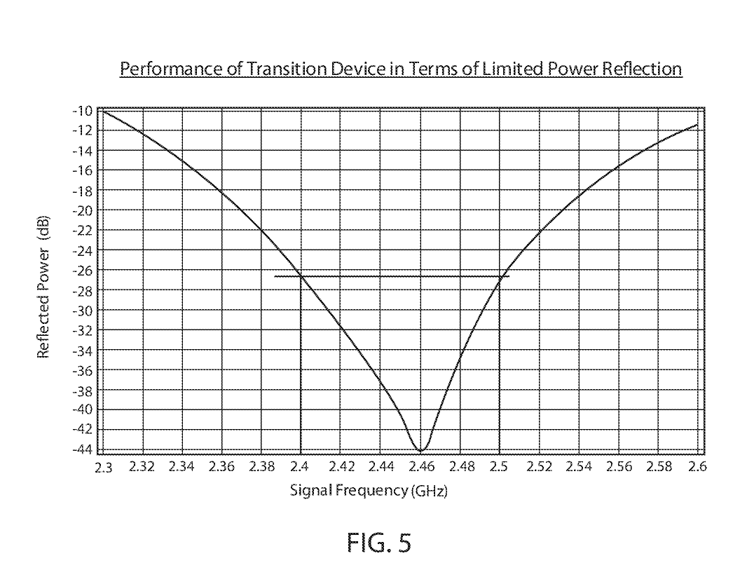

In some embodiments, the transmission line 14 may correspond to a coaxial transmission line or other forms of conductive connectors. The probe 30 may correspond to a core portion of the transmission line 14, and, in some embodiments, may be implemented to an antenna or a microstrip antenna. The operation of the transition device 10 may be derived based on the duality theorem of quantum mechanics such that the transition device 10 is optimized to propagate electromagnetic radiation through the hollow waveguide 12 at a desired frequency. In some embodiments, the desired frequency may be between approximately 2.4 and 2.5 GHz. As further discussed in reference to FIGS. 4 and 5, the performance of the transition device 10 may be optimized to transmit power from the inlet wall 16 to an outlet 34 depicted in FIG. 1 as a rectangular aperture formed in an exterior wall 36 of the waveguide 12.

In some embodiments, the waveguide 12 may comprise rectangular transition portion 38 formed perpendicular to the waveguide 12. The transition section 38 may perpendicularly or angularly align with a passage formed by the interior volume 28 of the waveguide 12. In this configuration, the transition section 38 may be configured to transmit the electromagnetic radiation upward from a linear portion of the waveguide 12 extending along the longitudinal axis to the outlet 34 formed in the exterior wall 36. In this way, the waveguide 12 may be configured to transmit the electromagnetic radiation through the interior volume 28 outward through the outlet 34.

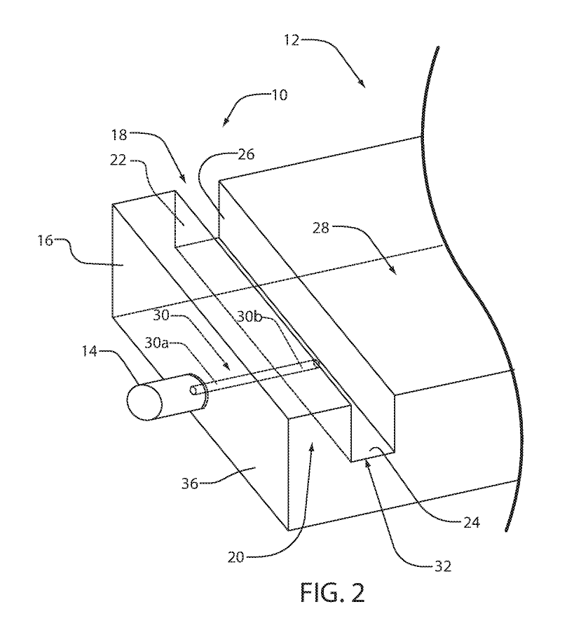

FIG. 2 demonstrates a detailed projected view of the transition device 10 of the waveguide 12 in accordance with the disclosure. Referring now to FIGS. 1 and 2, the distal end portion 30b of the probe 30 is shown extending from the proximal end portion 30a parallel to the tuning surface 32 formed by the base portion 24 of the rectangular channel 18. The distal end portion 30b may terminate proximate to the second wall 26 of the rectangular channel 18. In this configuration, electromagnetic radiation may be emitted radially outward from the probe 30 and substantially into the tuning surface 32 of the rectangular channel 18. Based on the configuration of the rectangular channel 18 and the cavity 20, the electromagnetic radiation emitted from the probe 30 may be controlled by the transition device 10 to propagate perpendicular to the longitudinal axis L of the waveguide 12 outward toward the outlet 34. In this configuration, the transition device 10 may provide for the electromagnetic radiation emitted from the probe 30 to be transmitted through the hollow waveguide 12 at a high level of efficiency. The propagation of the waves through the waveguide 12 is further discussed in reference to FIGS. 4 and 5.

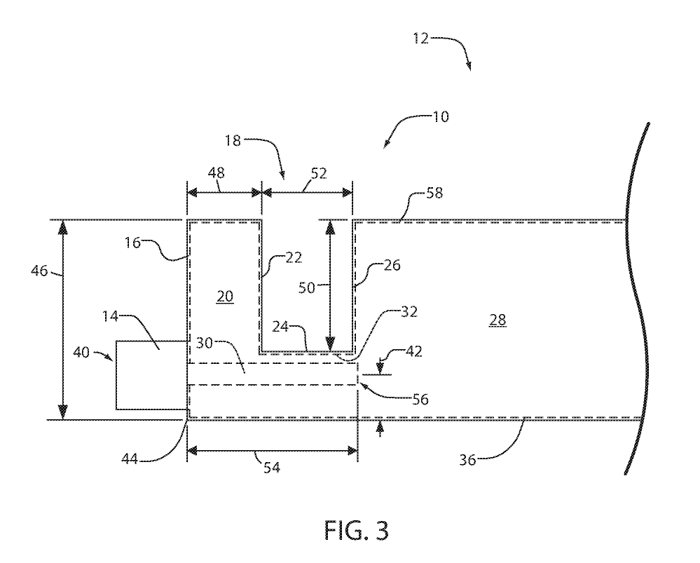

Referring now to FIG. 3, a detailed side cross-sectional view of the transition device 10 is shown. As discussed herein, the proportions of the rectangular channel 18 and the cavity 20 may provide for the efficient control and transmission of wavelengths through the waveguide 12 at a target frequency or frequency range. As demonstrated in FIG. 3, the specific proportions of an exemplary embodiment of the transition device 10 are demonstrated. Though the specific dimensional values for the proportions of the transition device 10 are discussed in reference to FIG. 3, the dimensions of the device may vary based on a desired frequency transmission range, proportions of the waveguide device, or various additional factors that may be understood to those having skill in the art. Accordingly, the invention as discussed herein may not be limited by the specific dimensional specifications provided here, which are provided to clearly describe at least one exemplary embodiment.

As demonstrated in FIG. 3, the transition device 10 may be configured having specific dimensional proportions. For example, the transmission line 14 may comprise a transmission line diameter 40 configured to engage the inlet wall 16 at an engagement height 42. Additionally, the cavity 20 may extend a cavity height 46 from a lower surface 44 of the transition device 10. In this configuration, the cavity 20 may extend above the transmission line 14 and the probe 30 creating a volumetric opening in contiguous connection with the interior volume 28 formed by the rectangular structure of the hollow waveguide 12. The cavity 20 may further extend forward from the inlet wall 16 to the first wall 22 along a cavity length 48. Accordingly, the cavity 20 may be formed above the probe 30 extending along the longitudinal axis L of the hollow waveguide 12 from the inlet wall 16 to the first wall 22 of the rectangular channel 18.

The rectangular channel 18 may comprise a channel height 50 formed by the first wall 22 and the second wall 26. The base portion 24 may separate the first wall 22 from the second wall 26 by a base length 52. In this configuration, a tuning surface 32 formed by the base portion 24 of the rectangular channel 18 may extend in a spaced configuration parallel to the probe 30. Additionally, as previously discussed herein, the probe 30 may comprise the distal end portion 30b extending from the proximal end portion 30a along a probe length 54. In this configuration, a probe diameter 56 or thickness of the probe 30 may terminate at the distal end portion 30b proximate to the second wall 26 of the rectangular channel 18.

Exemplary measurements for the dimensional characteristics of the longitudinal transition device 10 are provided in Table 1 to demonstrate the relative proportions of the characteristics that may provide the performance characteristics as discussed herein. Again, the dimensional values provided herein shall not be considered limiting to the scope of the disclosure. In general, the base length 52 of the rectangular channel 18 may be greater than the cavity length 48 of the cavity 20. Additionally, the channel height 50 may extend from an upper surface 58 to the base portion 24 such that the probe 30 is at least partially separated from the tuning surface 32 in a spaced configuration. Finally, the probe length 54 may be configured to extend such that the distal end portion 30b extends along the longitudinal axis L of the waveguide 12 from the inlet wall 16 to beyond the second wall 26 of the rectangular channel 18. As provided by the disclosure, additional characteristics of the longitudinal transition device 10 may be interpreted from the exemplary dimensions provided in Table 1.

TABLE 1
Exemplary dimensions for longitudinal transition device

| Element | | Dimension |
|---|---|---|
| No. | Element Description | (mm) |
| 40 | transmission line diameter | 9.0 |
| 42 | engagement height | 5.8 |
| 46 | cavity height | 28.0 |
| 48 | cavity length | 11.0 |
| 50 | channel height | 19.0 |
| 52 | base length | 12.0 |
| 54 | probe length | 24.5 |
| 56 | probe diameter | 3.0 |

Referring now to FIGS. 4 and 5, simulation results for the performance of the transition device 10 of the hollow waveguide 12 are now discussed in further detail. Referring first to FIG. 4, the transition device 10 is shown having an input signal with a target frequency simulated as an input to the transmission line 14. As shown, the target frequency of the input signal applied to the transmission line 14 may be approximately 2.4 GHz to 2.5 GHz. A plurality of magnetic field lines 62 are demonstrated as directional arrows indicating the direction of the electromagnetic field induced within the transition device 10 of the hollow waveguide 12. As shown, the magnetic field lines 62 radiate outward from the probe 30 into the interior volume 28 formed by the transition device 10. In the cavity 20, the magnetic field lines 62 flow approximately from the first wall 22 to the inlet wall 16. Additionally, the magnetic field lines 62 flow outward from the second wall 26 toward the outlet 34 of the waveguide 12. Based on the configuration of the rectangular channel 18 and the cavity 20, the magnetic field lines 62 in a body portion of the waveguide 12 propagate perpendicular to the longitudinal axis L of the hollow waveguide 12. In this way, the longitudinal transition device 10 discussed herein provides for the control of the electromagnetic field within the hollow waveguide 12 such that the magnetic field lines 62 are propagated perpendicular to the longitudinal axis L as the electromagnetic energy is transmitted through the hollow waveguide 12.

Referring now to FIG. 5, a plot of the power reflected back within the waveguide 12 to the inlet wall 16 is shown. The amount of power or electromagnetic energy reflected back to the inlet wall 16 is demonstrated at the target wavelengths ranging from 2.4 GHz to 2.5 GHz. For clarity, the amount of power reflected back to the inlet wall 16 may be an indication of negative performance characteristics that may limit the transmission of the electromagnetic energy from the waveguide 12 into a microwave heating cavity. As demonstrated in FIG. 5, at an exemplary target frequency of 2.46 GHz, the energy reflected back by the waveguide 12 to the inlet wall 16 is less than one percent (1%) of the total power delivered into the waveguide 12. Accordingly, the vast majority of the energy transmitted into the waveguide 12 through the transmission line 14 is transmitted outward from the waveguide 12 into the microwave cavity via the outlet 34. In this way, the longitudinal transition device 10 of the hollow waveguide 12 may provide for efficient operation and transmission of the electromagnetic energy into a microwave cavity.

It will be understood by one having ordinary skill in the art that construction of the described device and other components is not limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above is merely for illustrative purposes and not intended to limit the scope of the device, which is defined by the following claims as interpreted according to the principles of patent law, including the Doctrine of Equivalents.

What is claimed is:

1. A transition device for a hollow waveguide comprising:
a rectangular structure comprising an inlet wall and an interior volume extending from the inlet wall along a first longitudinal axis, wherein the inlet wall is configured to receive a transmission line comprising an antenna forming a proximal end proximate to the inlet wall and a distal end configured to extend into the rectangular structure; and
a channel formed in the rectangular structure, the channel comprising a base portion forming a tuning surface, wherein the tuning surface is configured to extend along a length of the antenna in a spaced configuration parallel to the first longitudinal axis.

2. The transition device according to claim 1, wherein the first longitudinal axis extends substantially parallel to a length of the transmission line.

3. The transition device according to claim 1, wherein the channel is arranged transverse to the first longitudinal axis of the rectangular structure and extends through a width of the waveguide.

4. The transition device according to claim 1, wherein the channel comprises a first wall and a second wall, wherein the first wall and the second wall are separated by the base portion.

5. The transition device according to claim 4, wherein the waveguide is configured to receive the antenna and the distal end terminates in the rectangular structure proximate to the second wall.

6. The transition device according to claim 1, wherein the channel forms a cavity extending from the inlet wall to a first wall of the channel.

7. The transition device according to claim 6, wherein the rectangular structure forms a contiguous interior volume configured to receive the antenna from the inlet wall.

8. The transition device according to claim 7, wherein the contiguous interior volume is partially bisected by the channel forming the cavity extending from the inlet wall.

9. The transition device according to claim 1, wherein the base portion extends from a first wall to a second wall of the channel.

10. The transition device according to claim 9, wherein the first wall and the second wall are substantially parallel to the inlet wall.

11. The transition device according to claim 1, wherein the channel is formed along a second longitudinal axis, wherein the second longitudinal axis is substantially perpendicular to the first longitudinal axis.

12. The transition device according to claim 11, wherein the channel forms a rectangular opening through the rectangular structure of the waveguide.

13. A method for generating an electrical field in a hollow waveguide comprising:
transmitting electrical current at a frequency into an inlet wall of the hollow waveguide via a transmission line;
emitting electromagnetic energy radially from an antenna at the frequency perpendicular to a longitudinal axis of the hollow waveguide;
tuning the electromagnetic energy via an excitation surface of a channel at least partially bisecting the hollow waveguide;
controlling the electromagnetic energy via the channel and a cavity extending between the inlet wall and the channel, wherein the electromagnetic energy is controlled to propagate parallel to the longitudinal axis.

14. The method according to claim 13, wherein the electromagnetic energy is controlled such that the field lines of the electromagnetic energy are arranged perpendicular to the longitudinal axis in the hollow waveguide.

15. The method according to claim 13, wherein the tuning comprises emitting the electromagnetic energy radially into a base portion of the channel through a gap formed between the antenna and the base portion.

16. A transition device for a hollow waveguide comprising:
an elongated rectangular structure comprising an inlet wall and an interior volume extending from the inlet wall along a longitudinal axis, wherein the inlet wall is configured to receive a transmission line comprising an antenna forming a proximal end proximate to the inlet wall and a distal end configured to extend into the rectangular structure; and
a capacitive channel formed through a width of the rectangular structure substantially perpendicular to the longitudinal axis, the capacitive channel comprising a base portion forming a tuning surface, wherein the tuning surface is configured to extend along a length of the antenna in a spaced configuration parallel to the longitudinal axis.

17. The transition device according to claim 16, further comprising:
a cavity formed by a first wall of the channel and the inlet wall.

18. The transition device according to claim 17, wherein the distal end of the antenna terminates proximate to a second wall of the channel.

19. The transition device according to claim 18, wherein the second wall of the channel is spaced apart from the first wall by the base portion.

20. The transition device according to claim 16, wherein the interior volume of the rectangular structure is at least partially bisected by the channel forming the cavity extending from the inlet wall.
